(19) United States
(12) Patent Application Publication
(10) Pub. No.: US 2005/0006894 A1
(43) Pub. Date: Jan. 13, 2005

(54) Spray

(75) Inventor: Akihiro Karasawa, Amagasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA SUIKOSHA, Amagasaki-shi (JP)

(21) Appl. No.: 10/802,800

(22) Filed: Mar. 18, 2004

(30) Foreign Application Priority Data
Jul. 11, 2003 (JP) 2003-195623
Oct. 16, 2003 (JP) 2003-356358

(51) Int. Cl. F16L 45/00

(52) U.S. Cl. 285/146.1; 285/126.1; 285/261

(57) ABSTRACT

A spray including a hollow main shaft, a main shaft rotation portion fitted to be rotatable around the main shaft, and an external ring fitted on the rotation portion. The external ring pressing the rotation portion onto the main shaft so that fluid cannot enter the interface between the rotation portion and the main shaft. The spray further including a three- or four-way joint connected to the rotation portion, an angle joint connected to the three- or four-way joint, and a nozzle joint connected to the three- or four-way joint or the angle joint. The nozzle joint having a nozzle end and a concave bearing portion end, where the bearing portion is closely fitted on a spherical joint portion of the angle joint thus allowing the connection angle to be freely changed. The rotation portion is rotated by the force of the fluid being sprayed out of the nozzle joint.

### BACKGROUND OF THE INVENTION

1. Field of the Invention

The present invention relates to a spray capable of spraying a fluid in all directions in three dimensions.

2. Description of Related Art

As a conventional spray for spraying a fluid such as water in three-dimensional directions, JP-A-9-220494 discloses a three-dimensional rotating-nozzle driving device.

In the device, the nozzle attachment position is adjusted and the device body is driven by the reaction force of spraying from the nozzle, to be rotated in a desired rotational speed. Thereby, water is sprayed in three-dimensional directions. The rotational speed is controlled by the friction force of oil.

However, the above three-dimensional rotating-nozzle driving device is complicated in structure though the control of rotation, position, etc., of the nozzle can be made accurately. There is a problem of an increase in manufacture cost.

### SUMMARY OF THE INVENTION

An object of the present invention is to provide a spray of a simple structure capable of spraying a fluid in all directions in three dimensions.

A spray according to the present invention comprises a hollow first main shaft through which a fluid pass; a main shaft rotation portion fitted on the first main shaft so as to be rotatable around the first main shaft; and an external ring fitted on the main shaft rotation portion. The external ring presses the main shaft rotation portion onto the first main shaft so that the fluid can not enter the interface between the main shaft rotation portion and the first main shaft. The spray further comprises a three- or four-way joint connected to the main shaft rotation portion. The three- or four-way joint has joint portions. At least the joint portions other than the joint portion connected to the main shaft rotation portion is substantially spherical. The three- or four-way joint can divide the fluid having passed through the main shaft rotation portion, in two or three directions. The spray further comprises an angle joint connected to the three- or four-way joint. The angle joint has at its one end a substantially spherical joint portion and at its other end a concave bearing portion. The bearing portion can be closely fitted on the joint portion and allows the connection angle to be freely changed. The spray further comprises a nozzle joint connected to the three- or four-way joint or the angle joint. The nozzle joint has at its one end a nozzle and at its other end a concave bearing portion. The bearing portion can be closely fitted on the joint portion and allows the connection angle to be freely changed.

The main shaft rotation portion is rotated by the force of the fluid being sprayed out of the nozzle joint. The angle between joints can be changed at the connection portion. As a result, the direction of spraying the fluid can be three-dimensionally selected. Further, by adequately selecting the number of connected joints, the size of the spray can be freely changed.

### BRIEF DESCRIPTION OF THE DRAWINGS

FIG. 1 is a sectional view of the whole of a spray according to a first embodiment of the present invention;

FIG. 2A is a plan view of a piece of a split main shaft rotation portion in the spray according to the first embodiment of the present invention;

FIG. 2B is a side view of the piece of the main shaft rotation portion in the spray according to the first embodiment of the present invention;

FIG. 3A is a sectional view of an external ring of an example of the embodiment of the spray according to the present invention;

FIG. 3B is a side view of the external ring of the example of the embodiment of the spray according to the present invention;

FIG. 4A is a sectional view of a four-way joint in the spray according to the first embodiment of the present invention;

FIG. 4B is a side view of the four-way joint in the spray according to the first embodiment of the present invention;

FIG. 5A is a sectional view of a three-way joint in the spray according to the first embodiment of the present invention;

FIG. 5B is a side view of the three-way joint in the spray according to the first embodiment of the present invention;

FIG. 6A is a sectional view of an angle joint of an example of the embodiment of the spray according to the present invention;

FIG. 6B is a side view of the angle joint of the example of the embodiment of the spray according to the present invention;

FIG. 7A is a sectional view of a nozzle joint of an example of the embodiment of the spray according to the present invention;

FIG. 7B is a side view of the nozzle joint of the example of the embodiment of the spray according to the present invention;

FIG. 8A is a side view of a second main shaft in the spray according to the first embodiment of the present invention;

FIG. 8B is a sectional view of the second main shaft in the spray according to the first embodiment of the present invention;

FIG. 9A is a side view of a first main shaft in the spray according to the first embodiment of the present invention;

FIG. 9B is a sectional view of the first main shaft in the spray according to the first embodiment of the present invention;

FIG. 10 is a sectional view of a first main shaft, a main shaft rotation portion, and an external ring in an assembled state in the spray according to the first embodiment of the present invention;

FIG. 11 is a sectional view of a second main shaft, a main shaft rotation portion, and an external ring in a assembled state in the spray according to the first embodiment of the present invention; and

FIG. 12 is a sectional view of the whole of a spray according to a second embodiment of the present invention.

### DESCRIPTION OF THE PREFERRED EMBODIMENTS

[First Embodiment]

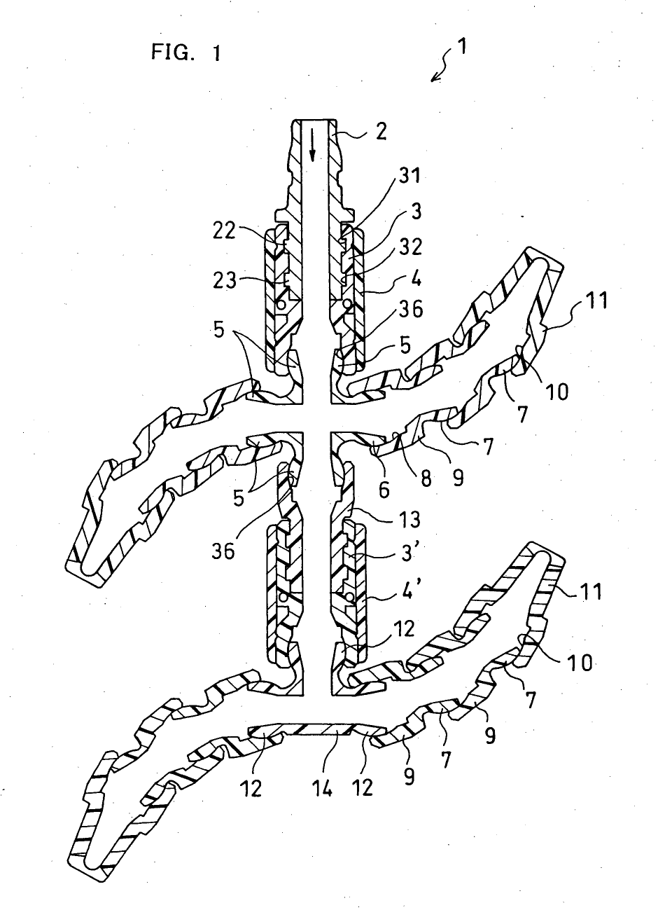

Referring to FIG. 1 that is a sectional view of the whole of a spray according to a first embodiment of the present invention, the spray 1 is made up of the following components. A hollow first main shaft 2 is to be connected and fixed to a non-illustrated fixed hollow pipe. A fluid flows through the pipe and the first main shaft 2. A main shaft rotation portion 3 is fitted on the first main shaft 2. The main shaft rotation portion 3 is rotatable around the first main shaft 2. An external ring 4 is fitted on the main shaft rotation portion 3. The external ring 4 clinches the main shaft rotation portion 3 to press the main shaft rotation portion 3 onto the first main shaft 2 so that the fluid can not enter the interface between the main shaft rotation portion 3 and the first main shaft 2. A four-way joint 6 is connected to the main shaft rotation portion 3. The four-way joint 6 has substantially spherical joint portions 5. The four-way joint 6 divides the fluid having passed through the main shaft rotation portion 3, in three directions. The connection angle of the four-way joint 6 relative to the main shaft rotation portion 3 can be arbitrarily changed. Angle joints 9 are connected to the four-way joint 6. Each angle joint 9 has at its one end a substantially spherical joint portion 7 and at its other end a concave bearing portion 8. The bearing portion 8 can be closely fitted on the corresponding joint portion 7 and the connection angle between them can be arbitrarily changed. Nozzle joints 11 are connected to the corresponding angle joints 9, respectively. One end portion of each nozzle joint 11 is formed into a nozzle shape. Each nozzle joint 11 has at its other end a concave bearing portion 10. The bearing portion 10 can be closely fitted on the corresponding joint portion 7 and the connection angle between them can be arbitrarily changed. A second main shaft 13 is connected to the four-way joint 6. A main shaft rotation portion 3′ is fitted on the second main shaft 13. The main shaft rotation portion 3′ is rotatable around the second main shaft 13. An external ring 4′ is fitted on the main shaft rotation portion 3′. The external ring 4′ clinches the main shaft rotation portion 3′ to press the main shaft rotation portion 3′ onto the second main shaft 13 so that the fluid can not enter the interface between the main shaft rotation portion 3′ and the second main shaft 13. A three-way joint 14 is connected to the main shaft rotation portion 3′. The three-way joint 14 divides the fluid being passing through the joint 14, in two directions.

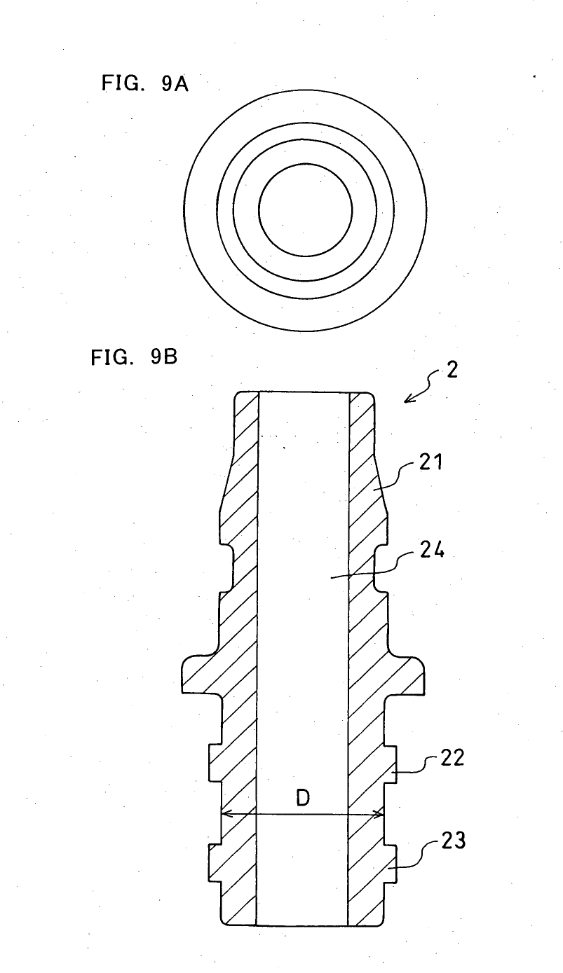

As illustrated in FIG. 9B that is a sectional view of the first main shaft, the hollow first main shaft 2 that is to be connected and fixed to a fixed pipe and allows a fluid to flow inside the first main shaft 2, has therein a passage 24 for the fluid. On the outer circumferential surface of the first main shaft 2 provided are a connection portion 21 to be fitted in the fixed pipe, and protrusions 22 and 23 for engaging with grooves of the main shaft rotation portion 3 as will be described later. The first main shaft 2 may be made of metal such as copper or stainless steel, or polyethylene terephthalate (PET).

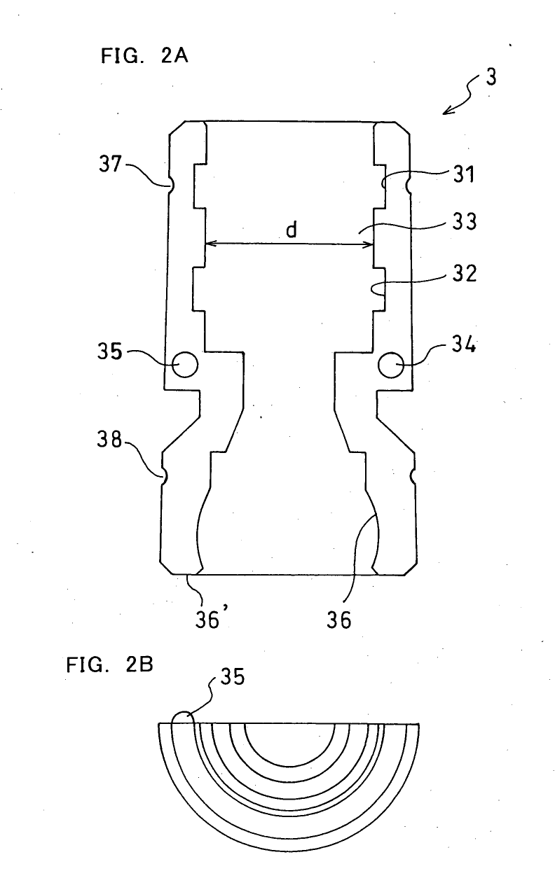

FIGS. 2A and 2B illustrate a piece of the split main shaft rotation portion 3 to be fitted on the first main shaft 2. As illustrated in FIGS. 2A and 2B, the main shaft rotation portion 3 can be split into two pieces. On the inside surface of the main shaft rotation portion 3 provided is a concave surface 33 to be fitted in the first main shaft 2. Grooves 31 and 32 are provided in the concave surface 33 for engaging with the respective protrusions 22 and 23 of the first main shaft 2 as described above. Each piece of the split main shaft rotation portion 3 has a recess 34 and a protrusion 35 for accurate positioning when assembling the pieces into the main shaft rotation portion 3. Because the main shaft rotation portion 3 can be split into two pieces, the grooves for fitting in the first main shaft 2 can be formed accurately. On the outer circumferential surface of the main shaft rotation portion 3, recesses 37 and 38 are provided for surely stopping and accurately positioning the fitted external ring 4 as will be described later. On the inside surface of the main shaft rotation portion 3, a bearing portion 36 formed into a concave shape is provided for being fitted on a joint portion 5 of the four-way joint 6. The concave bearing portion 36 is preferred to be a smooth spherical surface.

The difference (d−D) between the outer diameter D of the first main shaft 2 and the inner diameter d of the main shaft rotation portion 3, that is, space s between the first main shaft 2 and the main shaft rotation portion 3, is 0.1 mm or less, preferably, 0.05 mm or less. By limiting the space within the above range, when the main shaft rotation portion 3 is fitted on the first main shaft 2, the fluid can be prevented from entering the interface between them and the main shaft rotation portion 3 can rotate around the first main shaft 2.

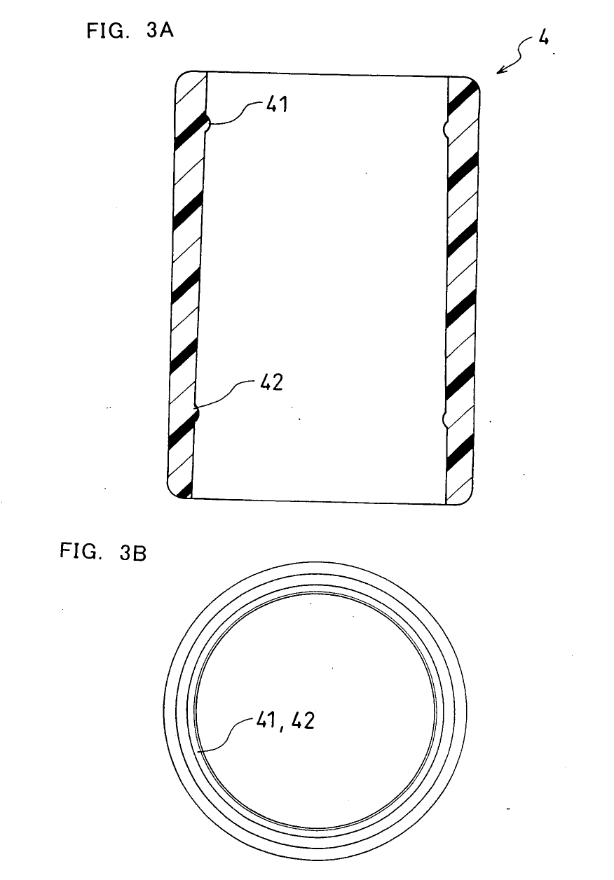

FIGS. 3A and 3B illustrates an external ring 4 to be fitted on the outer circumferential surface of the main shaft rotation portion 3. The external ring 4 presses the main shaft rotation portion 3 onto the first main shaft 2 so that the split main shaft rotation portion 3 can be surely supported on the first main shaft 2. As illustrated in FIGS. 3A and 3B, the external ring 4 is formed into a cylindrical shape. On the inside surface of the external ring 4 provided are protrusions 41 and 42 for engaging with the respective recesses 37 and 38 provided on the outer circumferential surface of the main shaft rotation portion 3. Thereby, when the external ring 4 is fitted on the main shaft rotation portion 3, the external ring 4 can be surely positioned and surely fixed. The recesses 37 and 38 and the protrusions 41 and 42 are preferably provided on the whole circumferences of the outside surface of the main shaft rotation portion 3 and the inside surface of the external ring 4, respectively, as illustrated in FIG. 3B. In a modification, however, protrusions and recesses are partially formed such that each protrusion can engage with the corresponding recess.

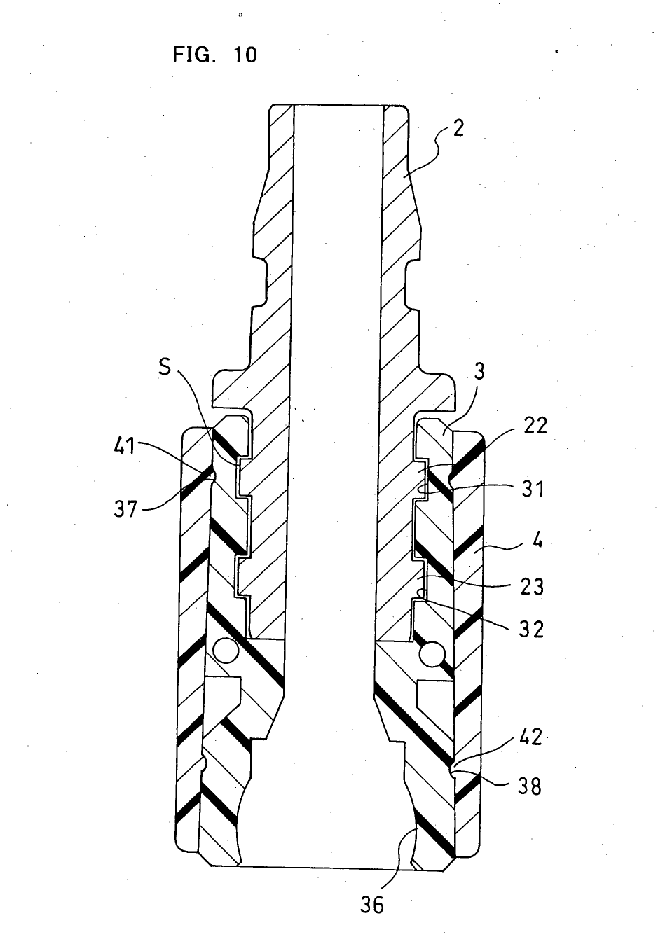

FIG. 10 illustrates the first main shaft 2, main shaft rotation portion 3, and external ring 4 in an assembled state. As illustrated in FIG. 10, the first main shaft 2 is sandwiched by the pieces of the split main shaft rotation portion 3. In this state, the main shaft rotation portion 3 is inserted in the external ring 4. Thereby, the main shaft rotation portion 3 is surely supported on the first main shaft 2 without slipping off. As illustrated in FIG. 10, space s is formed between the first main shaft 2 and the main shaft rotation portion 3. The space s does not allow the fluid to enter but allows the main shaft rotation portion 3 to smoothly rotate. The space s is 0.1 mm or less, preferably, 0.05 mm or less.

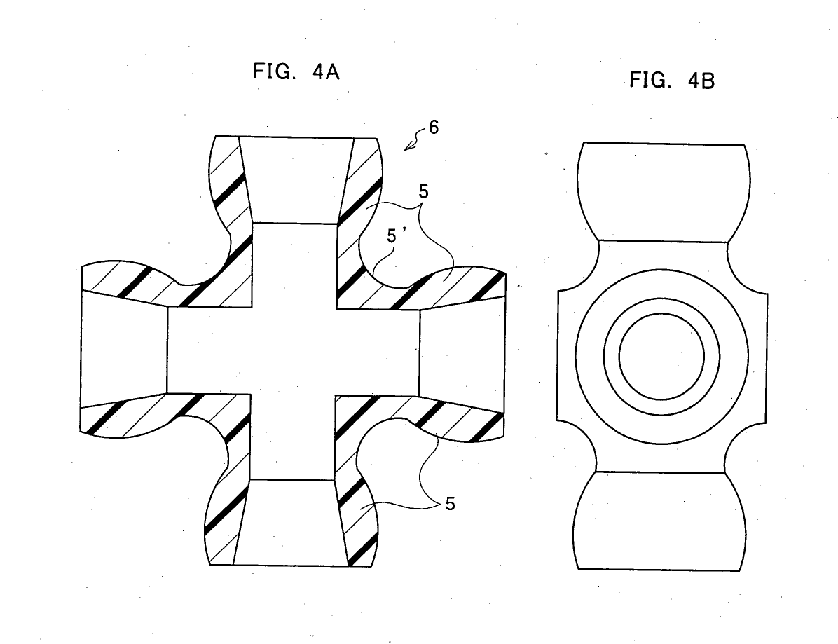

FIGS. 4A and 4B illustrate the four-way joint 6 to be connected to the bearing portion 36 formed into a concave shape of the main shaft rotation portion 3. The four-way joint 6 divides the fluid being passing through the four-way joint 6, in three directions. As illustrated in FIG. 4A, the four-way joint 6 has at each end portion a substantially spherical joint portion 5. The joint portion 5 has its outer diameter substantially equal to or somewhat larger than the inner diameter of the above-described bearing portion 36 of the main shaft rotation portion 3 or the bearing portion 8 of each angle joint 9 as will be described later, so that the joint portion 5 can be closely fitted in the bearing portion 36 or 8. Because the joint portion 5 is substantially spherical, when it is fitted in the bearing portion 36 of the main shaft rotation portion 3, the joint portion 5 can be moved along the concave surface of the bearing portion 36 to arbitrarily change the connection angle.

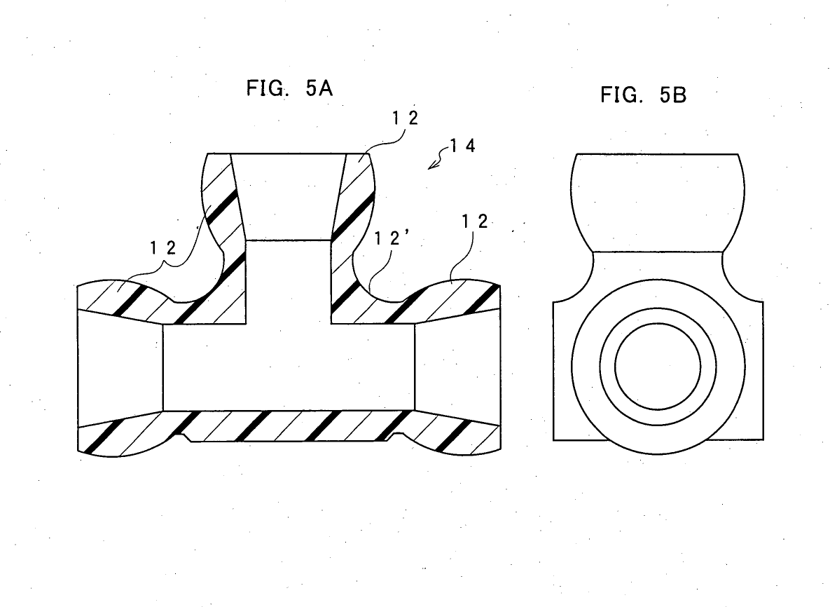

As illustrated in FIG. 5A that is a sectional view of the three-way joint for dividing the fluid in two directions, the three-way joint 14 has three joint portions 12 at the respective end portions, unlike the above-described four-way joint 6. Other than this, the three-way joint 14 has the same feature as the above-described four-way joint 6. Each joint portion 12 has its outer diameter substantially equal to or somewhat larger than the inner diameter of the bearing portion 36 of the main shaft rotation portion 3 or the bearing portion 8 of each angle joint 9 as will be described later, so that the joint portion 12 can be closely fitted in the bearing portion 36 or 8, like the joint portion 5 of the above-described four-way joint 6.

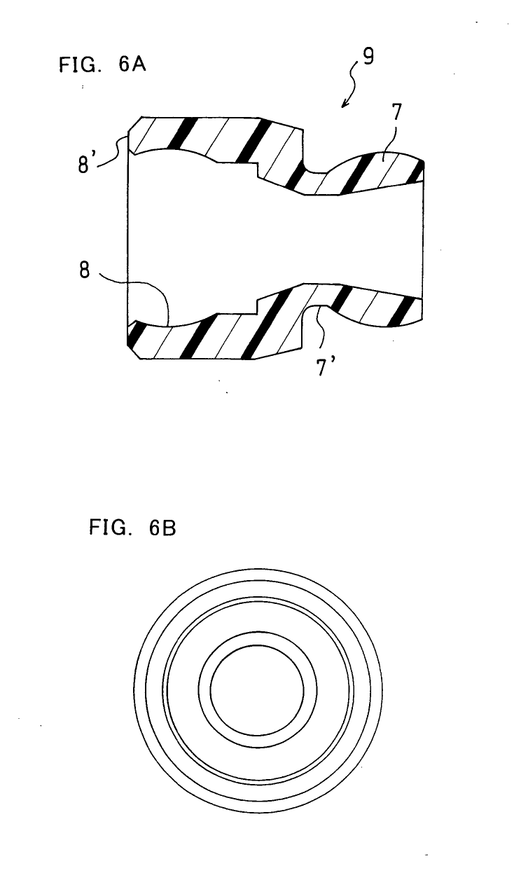

FIG. 6A is a sectional view of an angle joint 9 to be connected to the above-described four-way joint 6, three-way joint 14, or main shaft rotation portion 3, or another angle joint 9. The angle joint 9 makes it possible to control the connection angle between joints and the distance between joints. The angle joint 9 has at its one end portion a substantially spherical joint portion 7, and at its other end portion a bearing portion 8 formed into a concave shape. The bearing portion 8 can be closely fitted in the joint portion 7 of another angle joint 9, a joint portion 5 of the four-way joint 6, or a joint portion 12 of the three-way joint 14, such that the connection angle can be freely changed. The concave bearing portion 8 is preferred to be a smooth spherical surface.

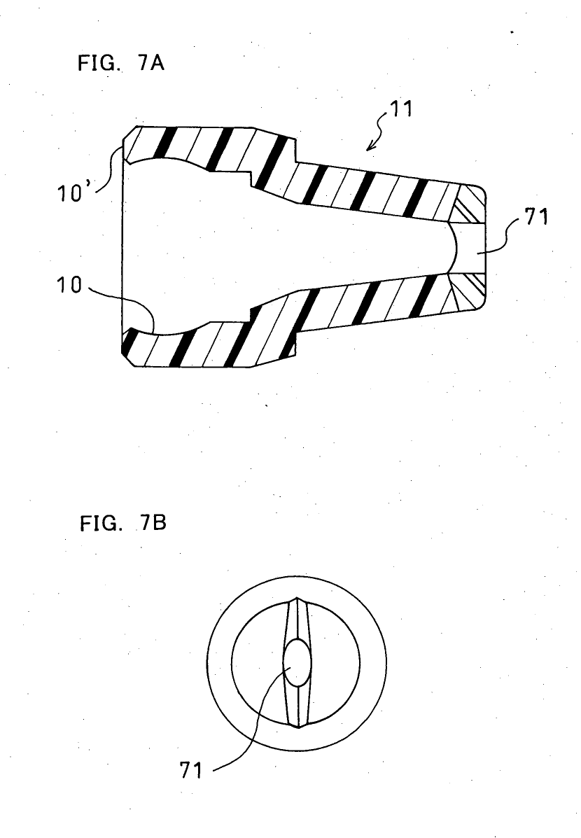

FIG. 7A is a sectional view of a nozzle joint 11 for spraying the fluid. One end portion of the nozzle joint 11 is formed into a nozzle shape having an opening 71 for spraying the fluid, as illustrated in FIG. 7B. As illustrated in FIG. 7A, the nozzle joint 11 has at its other end portion a bearing portion 10 formed into a concave shape. The bearing portion 10 can be closely fitted in the joint portion 7 of an angle joint 9, a joint portion 5 of the four-way joint 6, or a joint portion 12 of the three-way joint 14, such that the connection angle can be freely changed. The concave bearing portion 10 is preferred to be a smooth spherical surface.

As described above, any of the joint portions 5, 7, and 12 of the joints is substantially spherical, and any of the bearing portions 36, 8, and 10 of the joints to be fitted on the joint portions is formed into a concave shape so that face-to-face contact is made with the corresponding joint portion. Therefore, each of the joint portions 5, 7, and 12 can be rotated along the inside surface of any of the bearing portions 36, 8, and 10. In addition, because the joint portion is supported by face-to-face contact, the connected joints can be stopped at a desired angle. In this embodiment, any of the end faces 36′, 8′, and 10′ of the bearing portions 36, 8, and 10 can be stopped by the neck portions 5′, 7′, and 12′ of the joint portions 5, 7, 12 so that the angle between the connected joints may fall within a range of 20 degrees relative to the joint axis. Thereby, the pressure of the fluid being passing through each joint can not cause separation of the joints and a change in connection angle.

In the spray 1 of this embodiment, the second main shaft 13 is connected to the four-way joint 6 on the side opposite to the first main shaft 2. The above-described main shaft rotation portion 3′ with the above-described external ring 4′ is fitted on the second main shaft 13. The three-way joint 14 is connected to the main shaft rotation portion 3′. Thus, the spray 1 has two sets of nozzle portions each having a nozzle joint for spraying the fluid.

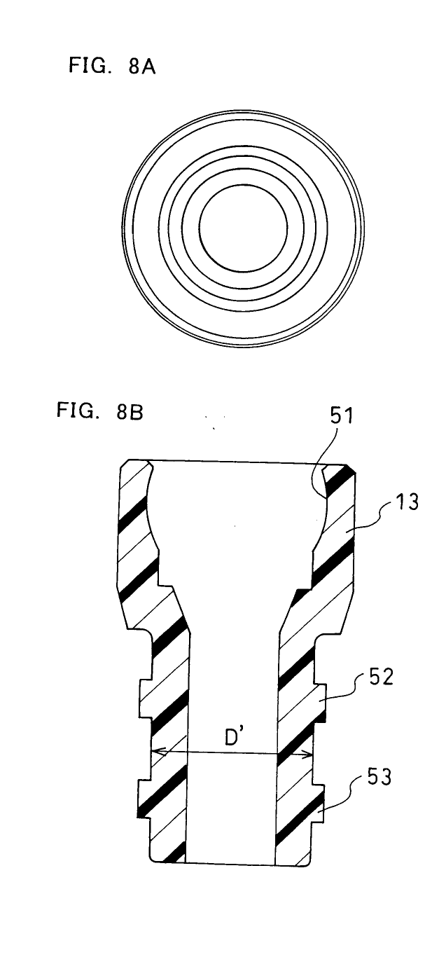

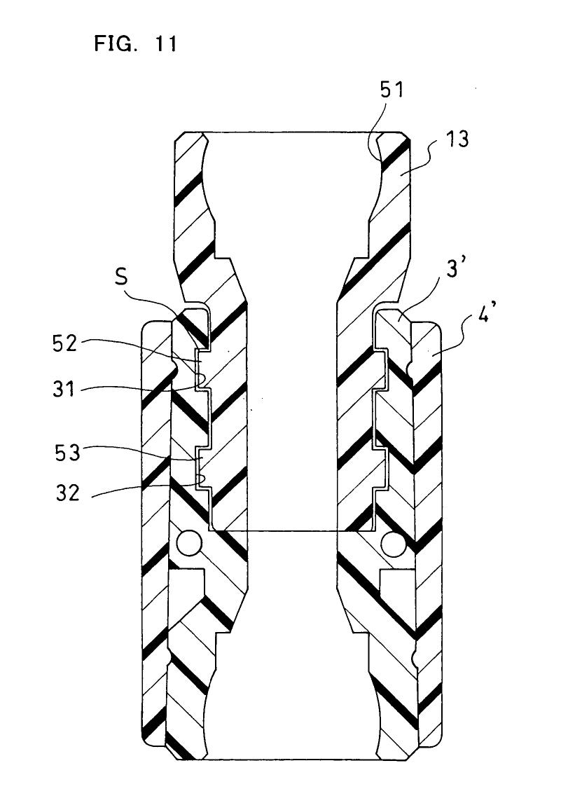

As illustrated in FIG. 8B that is a sectional view of the second main shaft, the second main shaft 13 to be connected to the four-way joint 6 has a bearing portion 51 having the same shape of those of the above-described joints, so that the bearing portion 51 can be closely fitted on a joint portion 5 of the four-way joint 6. The concave bearing portion 51 is preferred to be a smooth spherical surface. On the outer circumferential surface of the second main shaft 13 provided are protrusions 52 and 53 for engaging with grooves 32 and 31 of the main shaft rotation portion 3′. The outer diameter D′ of the second main shaft 13 is determined so as to have the same relation as the above-described relation between the outer diameter D of the first main shaft 2 and the inner diameter d of the main shaft rotation portion 3. That is, as illustrated in FIG. 11 that is a sectional view of the second main shaft 13, main shaft rotation portion 3′, and external ring 4′ in an assembled state, the outer diameter D′ is determined such that space s formed between the second main shaft 13 and the main shaft rotation portion 3′ is 0.1 mm or less, preferably, 0.05 mm or less. Thereby, with preventing the fluid from entering the space, rotation of the main shaft rotation portion 3′ is possible by the reaction force of the fluid being sprayed through each nozzle.

Each of the above-described main shaft rotation portion 3, three-way joint 14, four-way joint 6, angle joint 9, and nozzle joint 11, is made of PET. Therefore, these parts can be formed by injection molding. Because these parts are thus made of PET, they are light and can be inexpensively manufactured.

The spray 1 of the first embodiment is constructed as described above. In a state wherein the first main shaft 2 is connected to a non-illustrated fixed pipe or the like, a fluid is supplied into the spray 1 to spray the fluid from each nozzle joint 11.

As illustrated in FIG. 1, the fluid being passing through the spray 1 is divided in three directions by the four-way joint 6 and sprayed from nozzle joints 11. At this time, by receiving the reaction force of the fluid being sprayed from the tip end of each nozzle joint 11, the main shaft rotation portion 3 starts to rotate around the first main shaft 2. Further, the fluid that flowed in the second main shaft 13 is divided in two directions by the three-way joint 14 and sprayed out of the nozzle joints 11 connected to ends of the three-way joint 14. At this time, like the main shaft rotation portion 3, by the reaction force of the sprayed fluid, the main shaft rotation portion 3′ starts to rotate independently of the main shaft rotation portion 3 fitted on the first main shaft 2.

As described above, in the spray 1 of the first embodiment, the main shaft rotation portions 3 and 3′ rotate by the force of the fluid that passed through the main shaft rotation portions 3 and 3′ and is sprayed out of each nozzle joint 11. Upon this, by adjusting angle joints 9, nozzle joints 11, etc., in angle at each connection portion so that the nozzle joints 11 face in arbitrary directions, directions of spraying the fluid can be freely changed. Thus, the fluid can be sprayed in any direction in three dimensions.

[Second Embodiment]

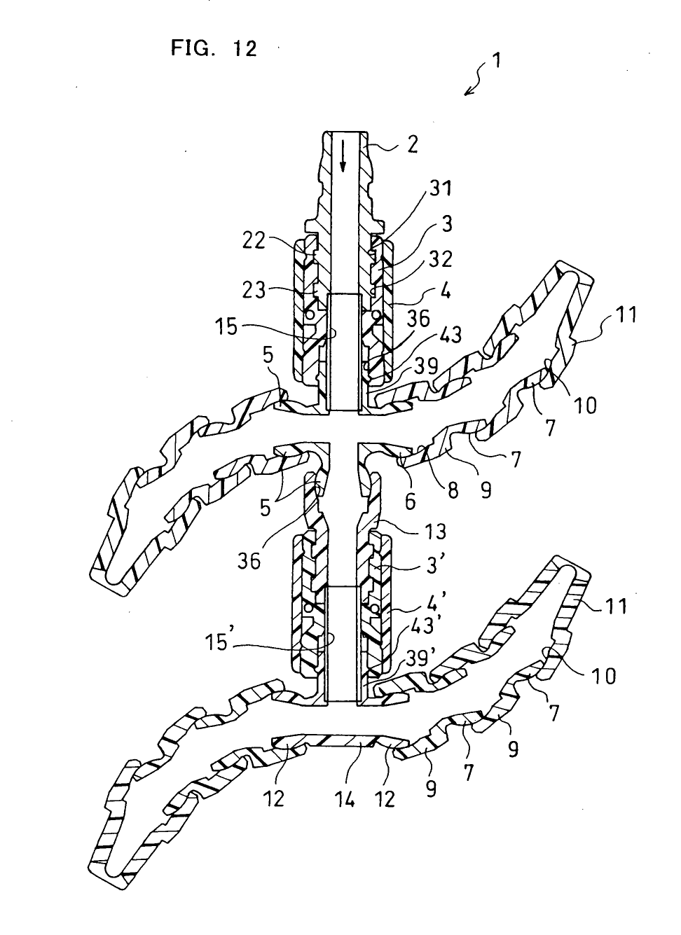

The construction of a spray according to a second embodiment of the present invention will be described with reference to FIG. 12. The second embodiment differs from the first embodiment in the following point. In the second embodiment, pipes 15 and 15′ are provided within the main shaft rotation portions 3 and 3′, respectively. The first main shaft 2 is connected to the four-way joint 6 through the pipe 15. The second main shaft 13 is connected to the three-way joint 14 through the pipe 15′. Each of the pipes 15 and 15′ is made of SUS 304 or the like. By the provision of the unbendable metallic pipes 15 and 15′, the connection portions between the main shaft rotation portions 3 and 3′ and the four- and three-way joints 6 and 14 can not be freely changed to arbitrary angles. More specifically, a joint portion 39 of the four-way joint 6 to be connected to the main shaft rotation portion 3 and a joint portion 39′ of the three-way joint 14 to be connected to the main shaft rotation portion 3′ are cylindrical. Protrusions 43 and 43′ provided on the outer circumferential surfaces of the joint portions 39 and 39′ engage with recesses 44 and 44′ provided on the inside surfaces of the main shaft rotation portions 3 and 3′, respectively. Thereby, the four- and three-way joints 6 and 14 are connected to the main shaft rotation portions 3 and 3′, respectively.

Either of spaces formed between the first main shaft 2 and the pipe 15 and between the four-way joint 6 and the pipe 15 is 0.05 mm or less, preferably, not less than 0.04 mm and not more than 0.05 mm. The same applies to spaces formed between the second main shaft 13 and the pipe 15′ and between the three-way joint 14 and the pipe 15′. Thereby, leakage of the fluid through the spaces can be prevented. Thus, the fluid flows within the pipes 15 and 15′ and never leaks through the connection portions of the first main shaft 2, three-way joint 14, four-way joint 6, and main shaft rotation portions 3 and 3′, or gaps between the pieces of the main shaft rotation portions 3 and 3′. The fluid having entered the spaces between the pipes 15 and 15′ and the first main shaft 2 and the four-way joint 6 is heated due to rotations of the main shaft rotation portions 3 and 3′ to vaporize. The vapor functions as a lubricant. In addition, because a quantity of heat is consumed for changing the fluid into vapor, there is an effect of cooling the main shaft rotation portions 3 and 3′. The other features of the second embodiment are the same as those of the first embodiment, and thus the description is omitted.

The present invention is not limited to the above-described embodiments. For example, the four-way joint 6 may not be used and the three-way joint 14 may be connected in place of the four-way joint 6. In this case, the spray 1 has a set of nozzle portions for spraying the fluid. Otherwise, in the example of FIG. 1, another four-way joint may be connected before the three-way joint 14. In this case, the spray 1 has three sets of nozzle portions.

The number of connected angle joints 9 can be adequately selected to control the length of each nozzle portion. Thus, the form can be freely changed in accordance with the application.

In the second embodiment, pipes made of a bendable material such as rubber can be used in place of the metallic pipes. In this case, the connection portions between the main shaft rotation portions 3 and 3′ and the four- and three-way joints 6 and 14 may be freely changed to arbitrary angles.

As described above, in a spray of the present invention, the number of nozzle portions, the length and angle of each nozzle portion can be adequately changed in accordance with the application. Therefore, there is no doubt that sprays of the present invention are usable in place of three-dimensional nozzles conventionally used. Besides, sprays of the present invention are usable for various other applications because of their inexpensiveness.

While this invention has been described with respect to specific embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A spray comprising:
a hollow first main shaft through which a fluid pass;
a main shaft rotation portion fitted on the first main shaft so as to be rotatable around the first main shaft;
an external ring fitted on the main shaft rotation portion, the external ring pressing the main shaft rotation portion onto the first main shaft so that the fluid can not enter the interface between the main shaft rotation portion and the first main shaft;
a three- or four-way joint connected to the main shaft rotation portion, the three- or four-way joint having joint portions, at least the joint portions other than the joint portion connected to the main shaft rotation portion being substantially spherical, the three- or four-way joint being capable of dividing the fluid having passed through the main shaft rotation portion, in two or three directions;
an angle joint connected to the three- or four-way joint, the angle joint having at its one end a substantially spherical joint portion and at its other end a concave bearing portion, the bearing portion being able to be closely fitted on the joint portion and allowing the connection angle to be freely changed; and
a nozzle joint connected to the three- or four-way joint or the angle joint, the nozzle joint having at its one end a nozzle and at its other end a concave bearing portion, the bearing portion being able to be closely fitted on the joint portion and allowing the connection angle to be freely changed,
the main shaft rotation portion being rotated by the force of the fluid being sprayed out of the nozzle joint.

2. The spray according to claim 1, wherein the main shaft rotation portion can be split into two pieces.

3. The spray according to claim 1, wherein the main shaft rotation portion has, at the connection portion to the joint portion, a concave bearing portion that can be closely fitted on the joint portion and allows the connection angle to be freely changed.

4. The spray according to claim 1, wherein the three- or four-way joint is connected to the first main shaft through a pipe provided within the main shaft rotation portion.

5. The spray according to claim 1, wherein the joint portion allows the connection angle to be changed within an angle range of 20 degrees relative to an axial center.

6. The spray according to claim 1, wherein each of the first main shaft, the main shaft rotation portion, the three- or four-way joint, the angle joint, and the nozzle joint, is made of polyethylene terephthalate (PET).
